(19) United States
(12) Patent Application Publication
(10) Pub. No.: US 2010/0265955 A1
(43) Pub. Date: Oct. 21, 2010

(54) CROSS LAYER ROUTING (XRP) PROTOCOL

(76) Inventors: Sung I. Park, Irvine, CA (US); Darryn A. Johnnie, Brea, CA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(21) Appl. No.: 12/425,753

(22) Filed: Apr. 17, 2009

(51) Int. Cl. H04L 12/56

(52) U.S. Cl. 370/400

(57) ABSTRACT

In one aspect, a method includes receiving a packet at a first node, the first node comprising a processor, determining, at the first node, whether a destination node of the packet is within a zone of the first node, using, at the first node, an on-demand routing protocol to route data from the first node to the destination node if the destination node is outside the zone of the first node and using a network topology, stored at the first node, to route the packet from the first node to the destination node if the destination node is within the zone of the first node.

### BACKGROUND

An optimal Mobile Ad hoc Network (MANET) protocol should rapidly adapt to constant changes in a network while providing maximum bandwidth efficiency to users. Generally, adaptability and bandwidth efficiency are often conflicting requirements since optimizing one requirement more often than not results in penalizing the other requirement. There have been many MANET protocols in academic literature that strive to strike the balance between adaptability and bandwidth efficiency. One of the major classifications used in classifying the existing MANET protocols observes how each protocol establishes a route. If a protocol constantly exchanges control messages to maintain routes, the protocol is called a proactive protocol. On the other hand, if a protocol discovers a route only when there is a need to transmit data, the protocol is called an on-demand protocol. The proactive protocol attempts to maximize its adaptability to changing network topologies at the expense of reduced data bandwidth by constantly exchanging control information. On the other hand, the on-demand protocol attempts to maximize the data bandwidth by transmitting control information only when it is necessary (i.e., on-demand) at the expense of diminished adaptability since the on-demand protocols adapt to the changes reactively. There have been many efforts to bridge the gap between the performances of the proactive and on-demand protocols.

One such effort is called a Zone Routing Protocol (ZRP) which combines both proactive and on-demand protocols in its routing approach. One key strength of ZRP comes from its hybrid approach which balances a proactive protocol and an on-demand protocol to complement each other's weakness while creating synergies in providing the optimal performance. ZRP achieves this balance by forming a routing boundary called a “zone.” The zone is defined based on based on a hop count. ZRP uses a proactive protocol for routing within the zone (called “intra-zone routing”) such as a destination sequenced-distance vector (DSDV) protocol and uses an on-demand protocol for routing outside the zone (called “inter-zone routing”) such as a dynamic source routing (DSR) protocol.

### SUMMARY

In one aspect, a method includes receiving a packet at a first node, the first node comprising a processor, determining, at the first node, whether a destination node of the packet is within a zone of the first node, using, at the first node, an on-demand routing protocol to route data from the first node to the destination node if the destination node is outside the zone of the first node and using a network topology, stored at the first node, to route the packet from the first node to the destination node if the destination node is within the zone of the first node.

In another aspect, an apparatus to route data includes circuitry to receive a packet at a first node, the first node comprising a processor, determine, at the first node, whether a destination node of the packet is within a zone of the first node, use, at the first node, an on-demand routing protocol to route data from the first node to the destination node if the destination node is outside the zone of the first node and use a network topology, stored at the first node, to route the packet from the first node to the destination node if the destination node is within the zone of the first node.

In a further aspect, an article includes a machine-readable storage medium that stores executable instructions to route data. The executable instructions cause a machine to receive a packet at a first node, the first node comprising a processor, determine, at the first node, whether a destination node of the packet is within a zone of the first node, use, at the first node, an on-demand routing protocol to route data from the first node to the destination node if the destination node is outside the zone of the first node and use a network topology, stored at the first node, to route the packet from the first node to the destination node if the destination node is within the zone of the first node.

### DESCRIPTION OF THE DRAWINGS

FIG. 1 is a prior art diagram of a communication network having nodes.

FIG. 2 is a prior art table indicating an example of network schedule of communications between the nodes of FIG. 1.

FIG. 3 is a prior art diagram of another communications network.

FIG. 4 is a neighborhood of a source node.

FIG. 5 is a prior art table of a neighbor matrix of FIG. 4 used in Node Activation Multiple Access (NAMA) scheduling.

FIG. 6A is an example of a network.

FIG. 6B is the network of FIG. 6A with routing tables in a reverse path formation.

FIG. 6c is the network of FIG. 6A with routing tables in a forward path formation.

FIG. 7 is an example of a table depicting IP and node ID information for nodes in the network of FIG. 6.

FIGS. 8A to 8C are examples of fields for a route request (RREQ) packet

FIGS. 9A to 9H are examples of routing tables.

FIG. 10 is a functional diagram of a node in the network of FIG. 6.

FIG. 11 is an example of fields used in a cross-layer routing protocol (XRP).

FIGS. 12A to 12C are examples of neighbor matrix tables.

FIG. 13 is a flowchart of an example of a process used in routing using XRP.

FIG. 14 is a block diagram of a node on which the process of FIG. 13 may be implemented.

### DETAILED DESCRIPTION

Described herein is a cross-layer routing protocol (XRP) that leverages the advantages of ZRP and overcomes most of its shortcomings. The primary difference between XRP and ZRP comes from XRP's use of a data link layer in performing intra-zone routing. XRP, unlike ZRP, is a cross layer routing protocol that efficiently merges the service provided at a Dynamic Mobile Ad hoc Network (MANET) On-demand (DYMO) routing layer (also known as a network layer) and a service provided at a Node Activation Multiple Access (NAMA) data link layer (also known as a medium access control (MAC) layer) in providing adaptive and efficient routing paradigm promised by ZRP. In the process of merging the two services at a different layer, XRP not only inherits ZRP's advantages but it also solves many of ZRP's shortcomings.

In order to describe XRP, the NAMA scheduling algorithm and the DYMO routing protocol are first described. As described herein, NAMA scheduling uses and maintains a network topology (e.g., a neighbor matrix 50) that is used by XRP for intra-zone routing.

In a shared network with multiple users sharing the same frequency, it is desirable to have only one user transmit data at a time. For example, if one user transmits data at the same time another user is transmitting data, collisions occur and data is generally corrupted and lost. One method to reduce collisions in the shared networks is to use time division multiple access (TDMA). TDMA enables several users to share the same frequency by dividing the use of the shared frequency into different timeslots, one user per timeslot. For example, the users transmit data in succession (i.e., one user transmits data after another user transmits data), each user using its own timeslot so that only one user transmits data during a timeslot.

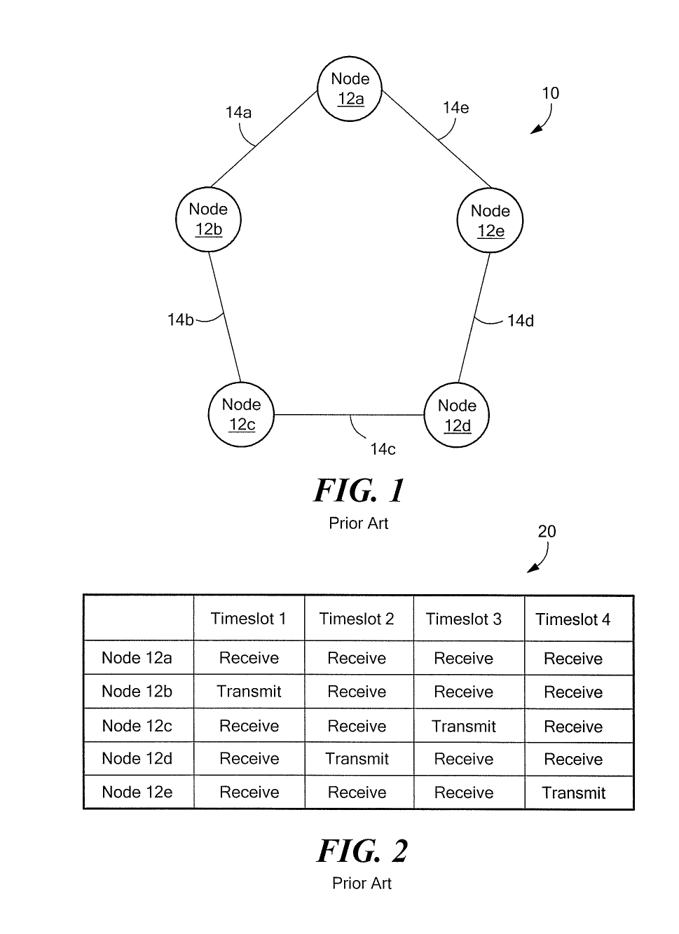

Referring to FIG. 1, a communications network 10 includes nodes (e.g., a first node 12a, a second node 12b, a third node 12c, a fourth node 12d and a fifth node 12e). In one example, the nodes 12a-12e are network routers. In another example, the nodes 12a-12e are wireless radios. The nodes 12a-12e are connected by links representing that the two nodes are within transmit/receive range of each other (e.g., a first link 14a connecting the first node 12a to the second node 12b, a second link 14b connecting the second node 12b to the third node 12c, a third link 14c connecting the third node 12c to the fourth node 12d, a fourth link 14d connecting the fourth node 12d to the fifth node 12e, and a fifth link 14e connecting the fifth node 12e to the first node 12a).

In one example, the links 14a-14e are wireless links. In another example, the links 14a-14e are wired links. In another example, links 14a-14e may be a combination of wireless and wired links. The communications network 10 may be any shared medium.

The first node 12a and the second node 12b are one hop away from each other (i.e., one-hop neighbors). One hop means that the shortest network path from the first node 12a to the second node 12b does not include any intervening nodes (i.e., one link). Likewise the second node 12b and the third node 12c; the third node 12c and the fourth node 12d; the fourth node 12d and the fifth node 12e; and the fifth node 12e and the first node 12a are all one-hop neighbors to each other.

The first node 12a and the third node 12c are two hops away from each other (i.e., two-hop neighbors). Two hops means that the shortest network path from the first node 12a to the third node 12c includes only one intervening node (the second node 12b) (i.e., two links). Likewise the second node 12b and the fourth node 12d; the third node 12c and the fifth node 12e; the fourth node 12d and the first node 12a; and the fifth node 12e and the second node 12b are all two-hop neighbors to each other.

A goal of network communications scheduling is to ensure that only one network node communicates at a time. For example, in a wireless network, if one node transmits data at the same time another node is transmitting data, collisions, which corrupt the data, will occur at a receiving node which is in wireless range of both transmitting nodes. One way used in the prior art to reduce collisions is to use time division multiplexing access (TDMA). One particular implementation of TDMA uses a Node Activation Multiple Access (NAMA) algorithm. NAMA is a wireless multiple access protocol designed to generate dynamic and collision-free TDMA timeslot scheduling. NAMA achieves collision-free TDMA timeslot scheduling by having nodes within one and two hops of each other participate in a cooperative random election process. Each node generates the same random algorithm to determine simultaneously which node transmits data for a particular timeslot.

For example, referring back to FIG. 1, the nodes 12a-12e implement an election process for four timeslots (e.g., timeslot 1, timeslot 2, timeslot 3 and timeslot 4). During each timeslot, each node 12a-12e in the network 10 determines a set of pseudo-random numbers based on each node's ID for those nodes that are within one or two hops distance. The assumption is that each node is aware of all other nodes (e.g., has the node ID of the other nodes) within a two-hop neighborhood. Since each node is using the same pseudo random number generation function to determine the random numbers, each node will come up with a consistent random value for each of the nodes within the two-hop neighborhood. Once a set of values is computed, the node with the highest value transmits during the timeslot.

In one particular example of determining random values, in timeslot 1, the first node 12a is determined to have a value of 4, the second node 12b is determined to have a value of 8, the third node 12c is determined to have a value of 1, the fourth node 12d is determined to have a value of 7 and the fifth node 12e is determined to have a value of 3. Since the second node 12b has the highest value, the second node is the only node that transmits during timeslot 1.

In timeslot 2, the first node 12a is determined to have a value of 3, the second node 12b is determined to have a value of 5, the third node 12c is determined to have a value of 4, the fourth node 12d is determined to have a value of 9 and the fifth node 12e is determined to have a value of 7. Since the fourth node 12d has the highest value, the fourth node is the only node that transmits during time slot 2.

In timeslot 3, the first node 12a is determined to have a value of 2, the second node 12b is determined to have a value of 1, the third node 12c is determined to have a value of 6, the fourth node 12d is determined to have a value of 3 and the fifth node 12e is determined to have a value of 5. Since the third node 12c has the highest value, the third node is the only node that transmits during time slot 3.

In timeslot 4, the first node 12a is determined to have a value of 4, the second node 12b is determined to have a value of 5, the third node 12c is determined to have a value of 2, the fourth node 12d is determined to have a value of 7 and the fifth node 12e is determined to have a value of 8. Since the fifth node 12e has the highest value, the fifth node is the only node that transmits during time slot 2.

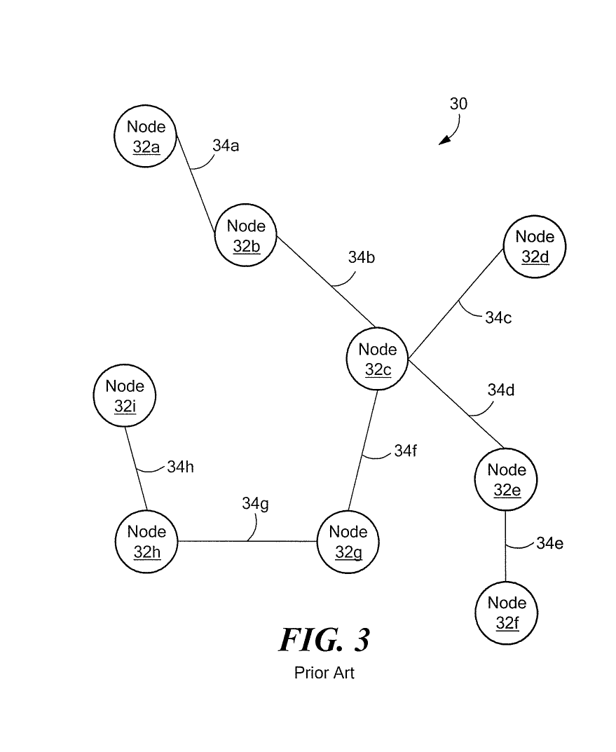

FIG. 2 includes a table 20 indicating a transmit schedule for the nodes during the four timeslots in the preceding example. The resulting schedule from the election process achieves a collision-free schedule by allowing only one node to transmit (within one- or two-hop neighbors) during each timeslot.

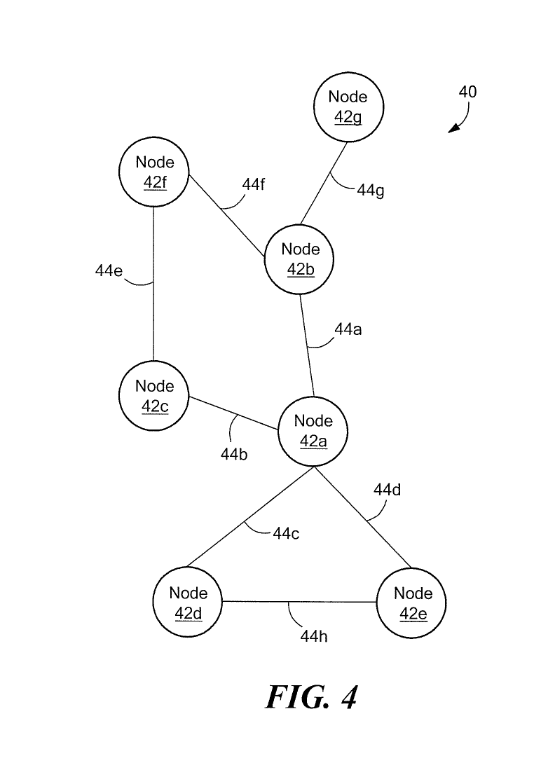

However, even using the NAMA technique, collisions may still occur if nodes are unaware of the other nodes. For example, referring to FIG. 3, a communications network 30 includes nodes (e.g., a first node 32a, a second node 32b, a third node 32c, a fourth node 32d, a fifth node 32e, a sixth node 32f, a seventh node 32g, an eighth node 32h and a ninth node 32i). The nodes 32a-32i are connected by links (e.g., a first link 34a connecting the first node 32a to the second node 32b; a second link 34b connecting the second node 32b to the third node 32c; a third link 34c connecting the third node 32c to the fourth node 32d; a fourth link 34d connecting the fourth node 32d to the fifth node 32e; a fifth link 34e connecting the fifth node 32e to the sixth node 32f; a sixth link 34f connecting the third node 32c to the seventh node 32g; the seventh link 34g connecting the seventh node 32g to the eighth node 32h; and the eighth link 34h connecting the eighth node 32h to the ninth node 32i).

In this example, the third node 32c has a neighborhood list (e.g., one-hop and two-hop neighbors) that includes the first node 32a, the second node 32b, the fourth node 32d, the fifth node 32e, the sixth node 32f, the seventh node 32g and the eighth node 32h. The ninth node 32i is not in the neighborhood list of the third node 32c because the eighth node is more than two hops away from the third node. The sixth node 32f only includes the fifth node 32e on its neighbor list, in this example. The sixth node 32f is missing the third node 32c (a two-hop neighbor) in its neighbor list. The sixth node 32f has view of the network topology that is inconsistent with the true topology of the network where the third node 32c and the sixth node 32f are two-hop neighbors.

Due to this inconsistency of the sixth node 32f not having the correct network topology, collisions can occur. In particular, using the NAMA technique, each node 32a-32i determines and evaluates the output of a random number function. For example, the first node 32a is determined to have a value of 4, the second node 32b is determined to have a value of 5, the third node 32c is determined to have a value of 9, the fourth node 32d is determined to have a value of 2, the fifth node 32e is determined to have a value of 6, the sixth node 32f is determined to have a value of 7, the seventh node 32g is determined to have a value of 2, the eighth node 32h is determined to have a value of 1 and the ninth node 32i is determined to have value of 8. The sixth node 32f determines that it can transmit during the timeslot since it has the highest output among its two-hop neighbors which only includes the fifth node 32e. Since the third node 32c also determines that it can transmit during the timeslot, the transmission from the third node 32c collides with a transmission from the sixth node 32f at the fifth node 32e.

It is therefore desirable in NAMA scheduling for each node to have a consistent view of the network in order to guarantee collision-free schedules. In contrast to prior art approaches, the description below focuses on an approach to improve network scheduling.

In a dynamic network, a consistency may be achieved by constantly exchanging control information among one-hop neighbors. The control information used in establishing consistency in NAMA scheduling includes at least the node ID of the originator and the node IDs of all the one-hop neighbors of the originator. Upon receiving control information, each node can build up a comprehensive list of neighbors using the node ID of the originator (which becomes one-hop neighbors of the receiver) and node IDs of the one-hop neighbors (which become two-hop neighbors of the receiver).

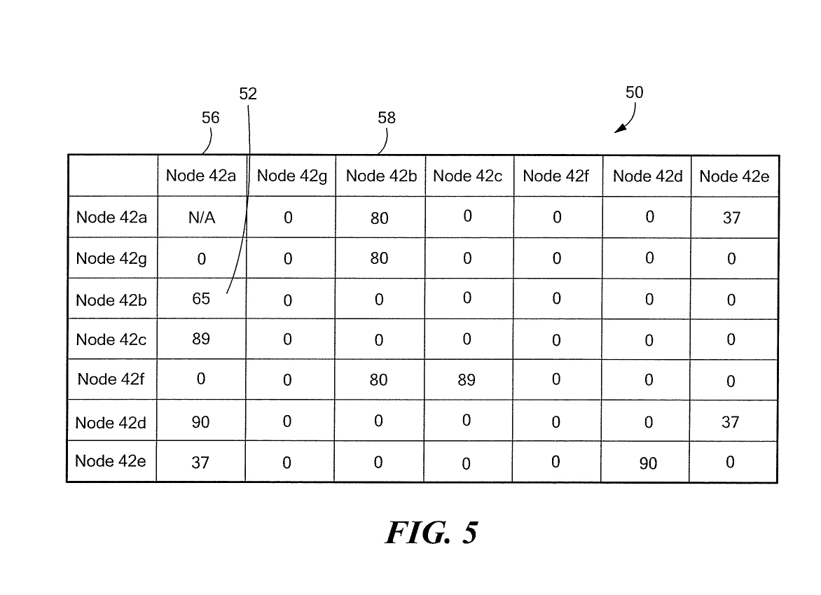

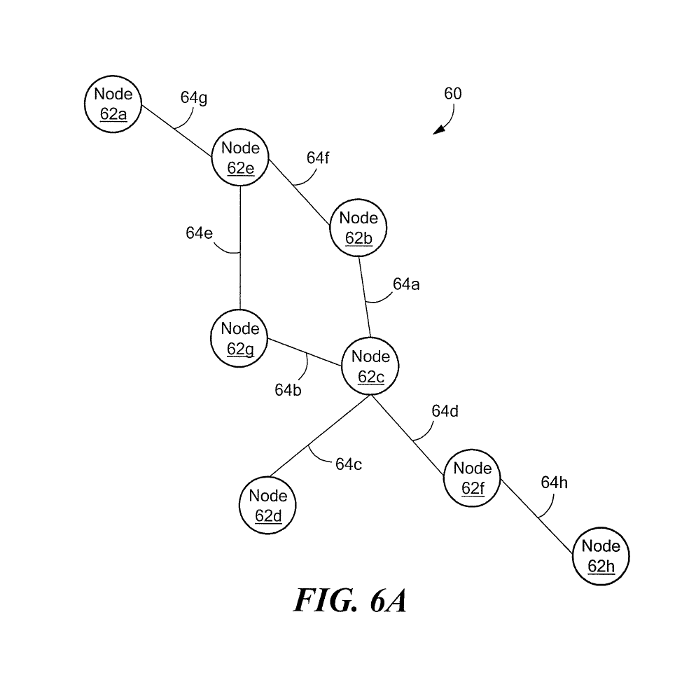

Referring to FIGS. 4 and 5, in one example, the network topology transmitted by each node may be represented using a neighbor matrix. For example, a neighbor matrix 50 of a node 42a represents a neighborhood 40 of node 42a. As will be described below, node 42a represents a source node as used in multicasting. The neighborhood 40 includes one-hop neighbors of node 42a (e.g., a node 42b, a node 42c, a node 42d and a node 42e) and two-hop neighbors (e.g., a node 42f and a node 42g). The nodes 42a-42g are connected by links 44a-44g. For example, the node 42b is connected to the node 42a by the link 44a, the node 42c is connected to the node 42a by the link 44b, the node 42d is connected to the node 42a by the link 44c, the node 42e is connected to the node 42a by the link 44d, the node 42f is connected to the node 42c by the link 44e, the node 42b is connected to the node 42f by the link 44f, the node 42b is connected to the node 42g by the link 44g and the node 42d is connected to the node 42e by the link 44h.

A nonzero value in the neighbor matrix 50 represents that a valid link is present for the node corresponding to the column to the node and the row. For example, the entry 52, having a value of 65, corresponds to the node 42b (i.e., the row) and the node 42a (i.e., the column) and indicates that a link exists from the node 42b to the node 42a (i.e., the link 44a). In one example, the nonzero value represents how long a corresponding link is valid. In one example, the higher the value the longer the link is valid.

Any nonzero value indicates that the corresponding nodes in the table (i.e., row and column) are one-hop neighbors. For example, under a column 56 for the node 42a, the nonzero values correspond to the node 42b, the node 42c, the node 42d and the node 42e and represent the one-hop neighbors of the node 42a. Nonzero value in the other columns (i.e., other than column 56) indicates that the corresponding node in the rows are the one-hop neighbor's neighbor (thus becoming two-hop neighbors of the node 42a). For example, a column 58 corresponding to the node 42b indicates that the one-hop neighbors of the node 42b are the node 42a, the node 42g, and the node 42f. Likewise, each column corresponding to node 42c, node 42e, and node 42d indicates each node's respective one-hop neighbors. Having each one-hop neighbor's neighbor captured in the neighbor matrix 50 accurately reflects the network topology shown in FIG. 4.

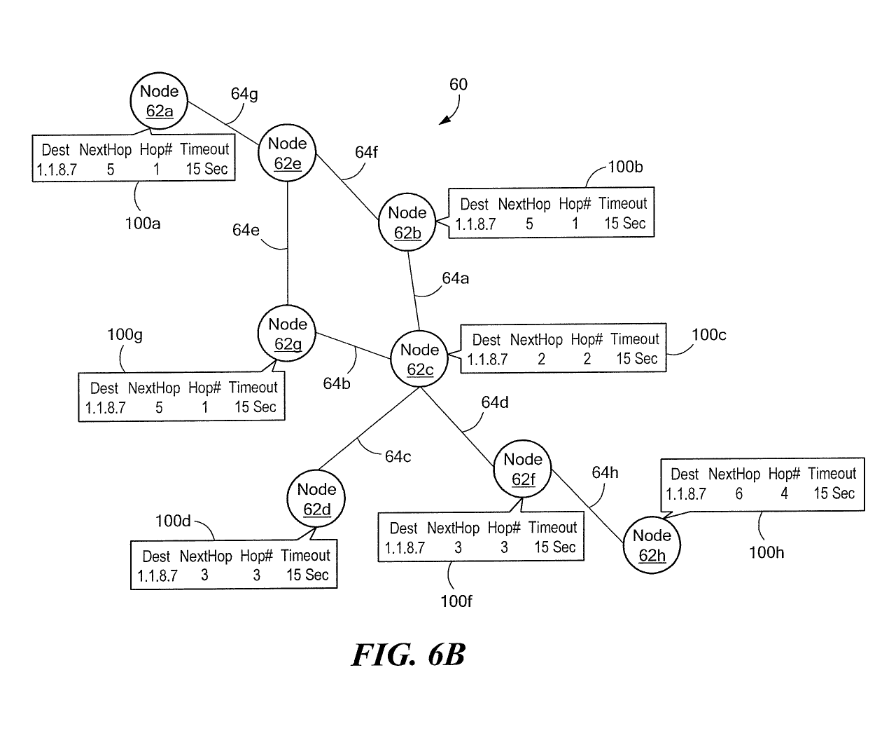

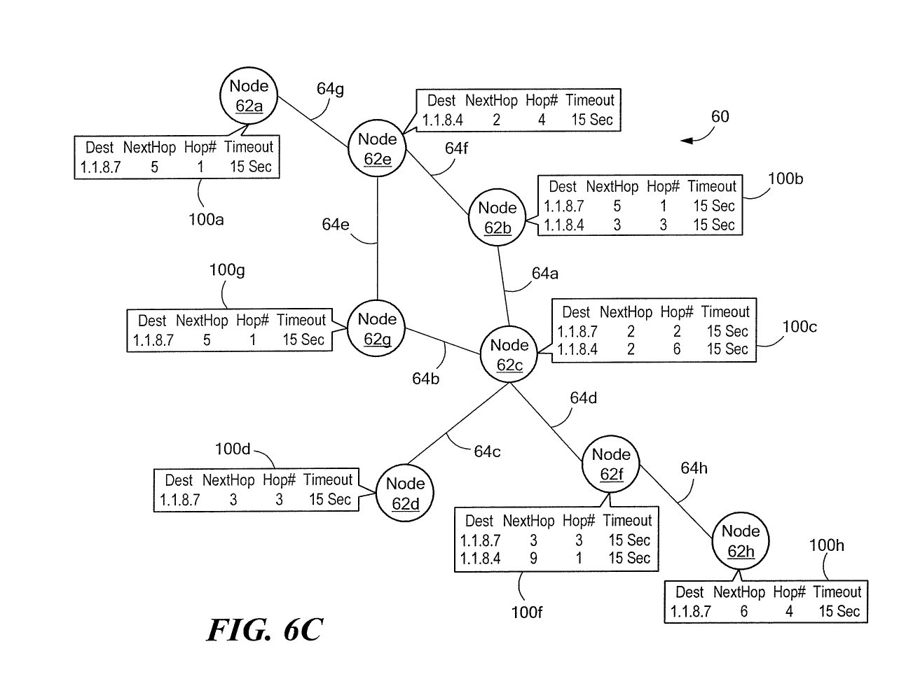

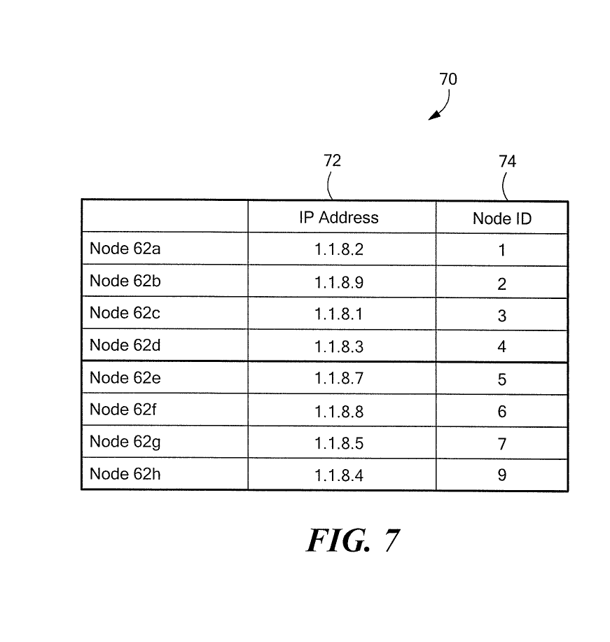

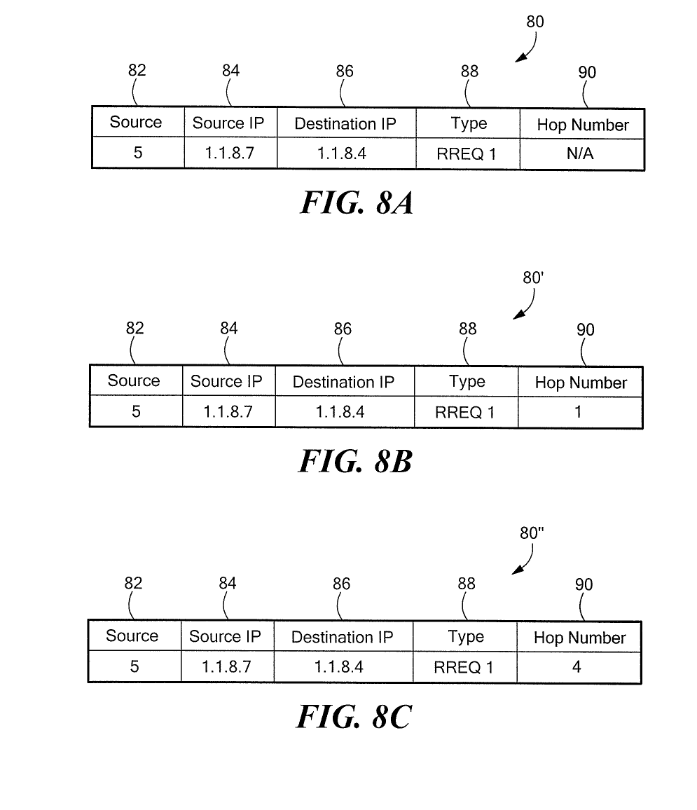

Referring to FIGS. 6A and 7, before describing the XRP, the DYMO routing protocol is first described with respect to a network 60. The network 60 includes nodes 62a-62g that are connected by links 64a-64g. For example, the node 62b is connected to the node 62c by the link 64a, the node 62c is connected to the node 62g by the link 64b, the node 62d is connected to the node 62c by the link 64c, the node 62f is connected to the node 62c by the link 64d, the node 62e is connected to the node 62g by the link 64e, the node 62b is connected to the node 62e by the link 64f, the node 62a is connected to the node 62e by the link 64g and the node 62f is connected to the node 62h by the link 64h. Each node 62a-62h includes a unique IP address 72 and is identified by a unique node ID number 74, a node address, such as described in table 70

The DYMO routing protocol is an internet MANET standard managed by Internet Engineering Task Force (IETF). In the DYMO routing protocol, there are two phases: a route discovery phase and a route maintenance phase.

The DYMO routing protocol is an on-demand protocol which discovers routes only when there is a need for discovering routes. This need arises whenever a source node attempts to transmit data across a network to a destination node that the source node has no route to deliver data. In the DYMO routing protocol, the source node's attempt to transmit data to an unknown destination node initiates the route discovery phase. The route discovery phase is started by the source node transmitting a control packet called a Route Request (RREQ) packet.

For example, in a beginning of a route discovery phase node 62e (a source node) tries to discover a route to node 62h (a destination node). When node 62e discovers that it has no existing route to node 62h, node 62e generates the RREQ packet which contains the IP address and node ID of the source (node 62e), IP address of the destination (node 62h), and sequence numbers associated with each address. A sequence number is a unique number that identifies the RREQ packet. When a node generates a RREQ packet, a unique sequence number is assigned to the packet. The RREQ packet also includes type and ID field indicating that it is a RREQ packet along with a metric which accumulates the cost of route the RREQ packet has taken so far in terms of hop count or link quality.

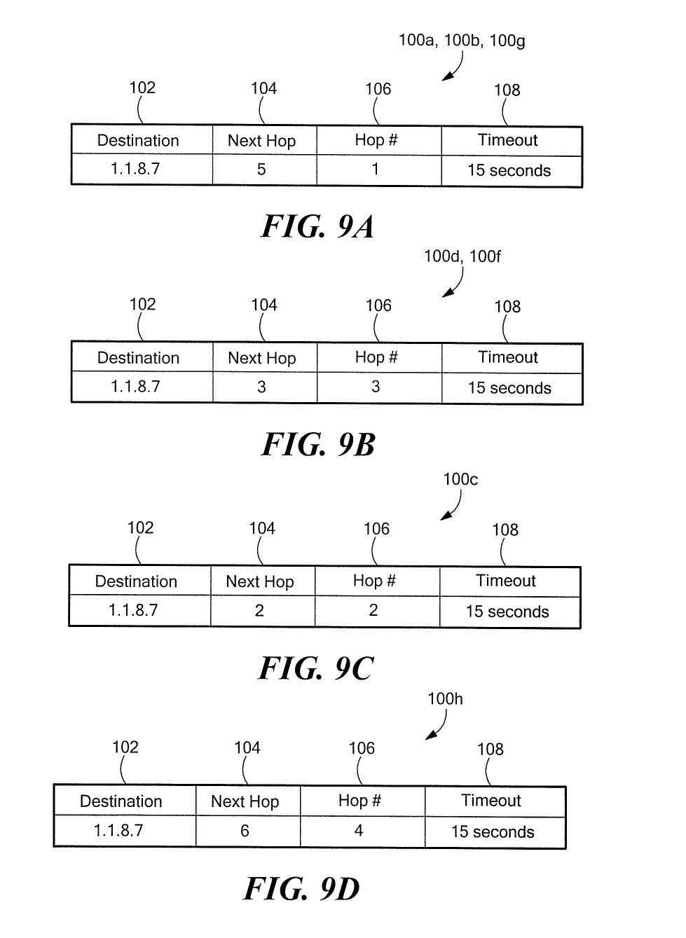

Referring to FIGS. 8A to 8C, in one example, the RREQ packet 80 includes a source field 82 to include the RSID of the source node (e.g., 5 for the node 62e), a source IP field 84 to include the IP address of the source node (e.g., 1.1.8.7 for the node 62e), a destination IP field 86 to include the IP address of the destination node (e.g., 1.1.8.4 for the node 62h), a message type and ID field 88 to include the type of message and ID (e.g., RREQ to represent RREQ packets and 1 to represent RREQ ID)and a hop number field 90 to indicate how may hops from the source node (FIG. 8A).

After constructing a RREQ packet, the source node (node 62e) broadcasts RREQ packet to the network 60. For example, nodes 62a, 62b, 62g include the RREQ packet 80′ having the fields 82-86 with the hop number field 90 storing a “1” to indicate that the nodes 62a, 62b and 62g are one hop from the source node 62e (FIG. 8B). In another example, at the destination node, the node 62h, the RREQ packet 80″ includes the fields 82-86 with the hop number field 90 storing a “4” to indicate that the node 62h is four hops from the source node 62e (FIG. 8C).

Each node receiving the RREQ packet first evaluates whether it has a route to the source node (node 62e) of the RREQ packet. If a node detects that the RREQ packet is not old (e.g., the route's source sequence number is greater or equal to RREQ source sequence number) and the RREQ packet has a fresher route (e.g., the route's source sequence number is greater than RREQ source sequence number) or it has a better route (e.g., route's metric is less than RREQ's route metric) to the source node 62e, the RREQ packet is accepted and processed. Otherwise, the RREQ packet is discarded by the intermediate node without further processing and forwarding. When a RREQ packet is processed by a node, the node processes the RREQ packet by generating a route entry that forms a route to the source node (node 62e) with the metric indicated by the RREQ packet. The process of forming routes to the source is called “reverse path formation.”

When node 62b first receives the RREQ packet from the node 62e, node 62b first examines its routing table to see if there is a current route entry corresponding to the source IP address of the RREQ packet (e.g., from the source IP field 84). If node 62b finds no reference to the IP address of node 62e (IP address 1.1.8.7) in its routing table, it processes the RREQ packet and generates a new route entry that points to the node 62e based on the information from the RREQ packet. The newly created route entry in node 62b provides information about how packets should be routed in order to get to the IP address 1.1.8.7 (node 62e). Each route entry also contains associated metric (hop count) and lifetime value.

One unique feature of the DYMO routing protocol is its soft-state approach in maintaining routes. Each route being established has the lifetime value associated with it. In one example, the lifetime value associated with the reverse path is 15 seconds. The lifetime value dictates how long the route is valid. If the route is not used to route packets within the lifetime value associated the route, the route automatically expires and each node deletes the route from its routing table. This lifetime based route maintenance or so called “soft-state” based approach ensures that freshest information is maintained at each node and any old or stagnant information does not linger in the network to adversely affect the routing functionality.

After processing the RREQ packet, node 62b forwards the RREQ packet to the network 60. The RREQ packet is processed and forwarded by each intermediate node until it reaches the destination node 62h. Also, when the RREQ packet reaches the node 62h, a reverse path from the node 62h to source node 62e is complete.

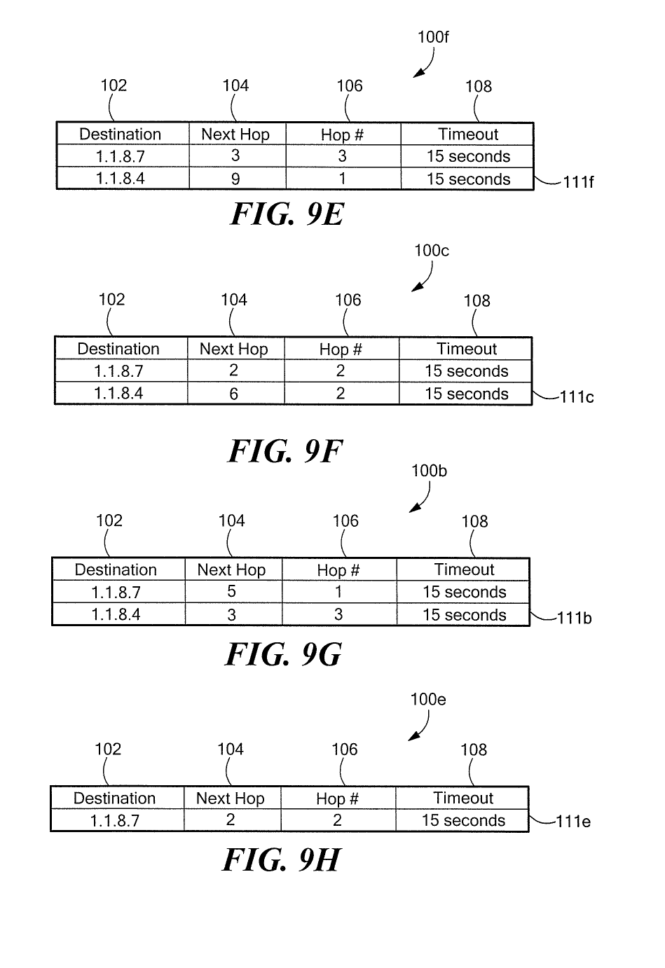

Referring to FIGS. 6B, 9A to 9D, in one example, a route that includes the nodes 62e, 62g, 62c, 62f, 62h is chosen. Routing tables 100a, 100b, 100g for the nodes 62a, 62b, 62g respectively includes an entry that includes a destination field 102 to designate the IP address of the source node (e.g., 1.1.8.7 for the node 62h), a next hop field 104 to indicate the node ID of the next hop (e.g., a “5” to indicate the node ID of the node 62e), a hop number field 106 to indicate the hop count of how many hops to the destination node (e.g., “1” to indicate one hop) and a timeout field 108 to indicate a lifetime value (e.g., 15 seconds) (FIG. 9A). In another example, routing tables 100d, 100f for the nodes 62d, 62f respectively includes an entry that includes the fields 102-108a with the next hop field 104 including a “3” to indicated the node ID of the node 62c and the hop number field 106 including a “3” to indicate that there are three hops to the source node 62e (FIG. 9B). In another example, a routing table 100c for the node 62c includes an entry that includes the fields 102-108a with the next hop field 104 including a “2” to indicated the node ID of the node 62b and the hop number field 106 including a “2” to indicate that there are two hops to the source node 62e (FIG. 9C). In a still further example, a routing table 100h for the node 62h includes an entry that includes the fields 102-108a with the next hop field 104 including a “6” to indicated the node ID of the node 62c and the hop number field 106 including a “4” to indicate that there are four hops to the source node 62e (FIG. 9D).

Another unique feature of the DYMO routing protocol is that DYMO routing protocol provides a single bi-directional route convergence feature. For example, it would have been possible for an alternate route using nodes 62e, 62g, 62c, 62f, 62h to be formed instead of choosing nodes 62e, 62g, 62c, 62f, 62h in FIGS. 9A to 9D. During route discovery phases, the DYMO routing protocol discovers multiple alternate routes from a source node to a destination node depending on actual network topologies. However, these alternate routes are purged either at the intermediate nodes or at the destination node based on a node's route metric and/or the order of the RREQ packet reception. In this example, the alternate route (i.e., using nodes 62e, 62g, 62c, 62f, 62h) was purged at the node 62c which chose the reverse path to the node 62b. Since the metric for both routes are identical (e.g., the hop count number in the hop number field 106 is 1 in both nodes 62f and the node 62b), the node 62c choice is based on the order of the RREQ packet reception.

Once the destination node 62h receives the RREQ packet, the RREQ packet is evaluated for the freshness of the RREQ packet by examining the source sequence number field which is associated with the source IP address. If the destination node 62h determines that the RREQ packet is not an old RREQ packet and the RREQ packet is either fresher or has a better metric than the one that the node processed previously, the node then proceeds with constructing a Route Reply (RREP) packet. The RREP packet includes information derived from the received RREQ packet. For example, the RREP packet includes a destination field and a source field that are simply reversed from the original RREQ packet and the RREP packet includes an ID field that corresponds to the original RREQ's ID field to match the RREP packet with the original RREQ packet. After constructing the RREP packet, the destination node 62h then transmits the RREP packet back to the source node 62e using the reverse path formed by the RREQ packet.

Referring to FIG. 6C, 9E to 9H as the RREP packet is forwarded traversing the reverse path formed at each node along the path, each node processes the RREP packet by forming a route to the source of RREP packet (e.g., the node 62h) which is also the destination of the original RREQ packet. This path, called a forward path, is constructed much the same way the reverse path is formed. Each node as it receives the RREP packet examines if there is a better route to the source of the RREP packet (e.g., the node 62h). If it finds that it doesn't have a better route, then each node inserts a new route entry to the source of the RREP and forwards the RREP packet along the reverse path formed by the RREQ packet. This process allows the intermediate nodes along the reverse path to form a fully bidirectional path. For example, the route entry table 100f for the node 62f, the route entry table 100c for the node 62c, the route entry table 100b for the node 62b and a route entry table 100e for the node 62e include a respective entry 111f, 111c, 111b, 111e reflecting the reverse path. Once the RREP packet arrives at the source of the RREQ packet (e.g., the node 62e), the source node (e.g., the node 62e) then has the route to the destination node (the node 62h) and starts to transmit the data using the IP address (e.g., 1.1.8.4) of the destination node 62h. As the data flows, each intermediate node uses its routing table to forward the data according to the route entries created during the route discovery phase. As long as the data flows through the route using the route entry, the expiration time is renewed for each intermediate node that is included in the route. For the nodes that have routes that have not been selected (e.g., nodes 62a, 62f, 62d), after the timeout period (e.g., 15 seconds), the route entry will be expired and removed from their respective routing tables leaving no residual information regarding the route.

Turning to the DYMO routing protocol route maintenance, once a bi-directional route is established between the source node 62e and the destination node 62h, the route remains active as long as the route is utilized for any data traffic. When the data stops flowing for the duration equal to the lifetime associated with the route, the DYMO routing protocol uses a soft-state approach that enables the route to simply expire without requiring an explicit message to take down the route. However, if any of the links along the route breaks due to mobility or hardware shutdown/failures, the DYMO routing protocol has a mechanism to rediscover an alternate route to the destination. In such a case, the DYMO routing protocol uses a special control packet called a Route Error (RERR) packet in order to explicitly take down the broken route and reestablish an alternate route.

Each node running the DYMO routing protocol constantly monitors its neighbor information through NAMA. If NAMA reports that one of the neighbor nodes (that one or several DYMO's existing routes used as their next hop neighbor) is no longer the node's one-hop neighbor, the DYMO routing protocol then constructs the RERR packet that contains information about the impacted route. The information contained in the RERR packet includes the IP address of the destination unreachable by the route failure, the last known sequence number for the destination, and type and ID field indicating the packet is an RERR packet. For the route that includes the nodes 62e, 62g, 62c, 62f, 62h if the link 64a between the node 62b and the node 62c breaks due to mobility, node failures, or RF interference, the nodes 62b, 62c detect that they can no longer serve the existing route to node 62e (for the node 62c) and to node 62h (for the node 62b). The node 62b forms an RERR packet that indicates that the node 62e is no longer reachable and the node 62b forms an RERR packet that indicates that the node 62h is no longer reachable and each node 62b, 62e broadcasts its respective RERR packet out to the network 60.

Each node receiving an RERR packet has to evaluate its own routing table 100 in order to determine if it has a route to the unreachable destination. There are two conditions that are checked for determining whether a particular route is associated with the unreachable destination. First condition is whether the destination IP address corresponding to a route entry matches the unreachable destination IP address included in the RERR packet. Once the node finds a matching entry, it then needs to consider the second factor which is whether the previous hop that transmitted the RERR packet is used as the next hop of the route entry. If both of these conditions are met, the matching route entry is removed from the routing table and the RERR packet is broadcasted. Otherwise, the node simply drops the RERR packet without forwarding the RERR packet back out to the network 60. Since the RERR packets are forwarded by only those nodes carrying the impacted route, even though RERR packets are broadcasted, they only traverse the impacted route dismantling the broken route on the way.

For example, when the node 62f receives the RERR packet from the node 62c, the node 62f checks for the first condition by examining its own routing table against the unreachable IP address indicated in the RERR packet. The node 62f then finds a routing table corresponding to the IP address 1.1.8.7 which is indicated to be unreachable. The node 62f checks for the second condition by examining whether the next hop field of the matching route entry is equal to the previous hop that the RERR packet has been transmitted from. In the example, the matching route entry's next hop (the node 62c) is equal to the source ID field of the RERR packet. Since both conditions are met, node 62f removes the route entry corresponding to the IP address 1.1.8.7 and forwards the RERR packet. With respect to the nodes 62d, 62g which also receive RERR packets from the nodes 62c and 62b respectively, each node rejects the RERR packet since each of these nodes do not contain a route corresponding to the unreachable destination contained in the RERR packet.

Upon receiving the RERR packet from the node 62b, the node 62e follows the same RERR processing algorithm to remove its own route to the destination node 62h. If there is no data flowing to the destination node 62h, the node 62e no longer attempts to find any alternate route. However, if there is still data being transmitted from the application layer for node 62h, the data then triggers a new round of a route discovery. In one example, the route discovery mechanism is the same as previously described. After going through a RREQ packet and a RREP packet exchange, if there is an alternate route to the destination node 62h, a new route will be discovered.

Turning to XRP, XRP is similar to ZRP in that there is a notion of a zone. However, instead of being arbitrary defined by the routing protocol as in ZRP, XRP's zone is defined by NAMA which is the data link layer protocol. In one example, NAMA, based on its inherent scheduling algorithm, defines each zone to be a two-hop distance, for example.

The inter-zone routing in XRP is done by the DYMO routing protocol which allows each node along a route to have state information about the route that it is serving. This is in contrast to ZRP's approach of using a dynamic source routing (DSR) approach where the state information is only stored in the source.

The intra-zone routing in XRP is performed by NAMA which is a data link layer protocol. This allows the routing layer to operate a single routing protocol without creating extra routing overhead for intra-zone routing.

Each node using NAMA has complete topology knowledge of its one- and two-hop neighbors based on the neighbor information provided by NAMA (e.g., through a neighbor matrix 50). The neighbor information can then be used in routing user data within one- and two-hop neighborhoods which are defined, for example, to be XRP's zone.

XRP builds on the on-demand routing functionality in the DYMO routing protocol and NAMA's neighbor matrix in achieving efficient and adaptive routing paradigm. XRP's routing paradigm follows the DYMO routing protocol routing mechanism which includes route discovery phase and route maintenance phase. During each phase, each node decides whether it should use intra-zone routing using the NAMA data link layer or inter-zone routing using the DYMO routing protocol in network layer depending on whether the destination node is located within the zone or outside the zone. In one example, the zone in XRP is defined to be a two-hop distance to coincide with the characteristics of NAMA algorithm which keeps track of neighborhood topology up to two hops. However this limit can be also changed if NAMA is modified to track up to n number of hop neighbors in its neighbor matrix.

XRP's approach of using data link layer and routing layer for routing enables a modular design of two separate routing paradigms (e.g., proactive and on-demand) at each layer. However, since the routing and data link layers requires cooperate in forming a routing decision, each layer needs to be able to exchange information and understand each other's information.

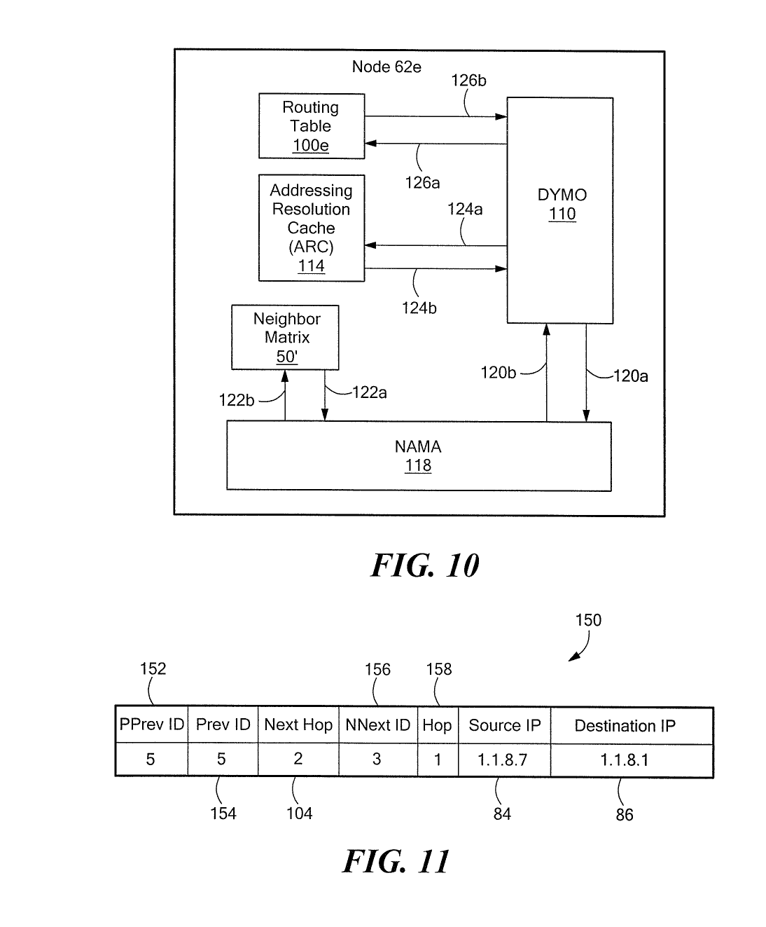

Referring to FIG. 10, a node (e.g., the node 62e) includes a DYMO routing protocol 110, the routing table 100e, an address resolution cache (ARC) 114, a NAMA scheduling protocol 118 and a neighbor matrix 50′. Since the DYMO routing protocol 110 uses an IP addressing scheme and the NAMA scheduling protocol 118 uses the data link layer Medium Access Control (MAC) addressing scheme (i.e., an node ID scheme), a mechanism is used where the addressing scheme for one can be translated to the other addressing scheme. For example, this translation mechanism can be implemented in a form of the ARC 114. The ARC 114 is used in XRP for DYMO routing protocol 110 to translate IP addresses to corresponding node IDs used by the NAMA scheduling protocol 118 and vice versa. In one example, the ARC 114 is a look-up table that includes entries that include IP address-to-node ID translation such as the table 70 in FIG. 7, for example. The ARC 114 may also be implemented as a move-to-front (MTF) cache which orders its entries based on how recent the entries have been accessed. An advantage of using the MTF cache as opposed to a simple queue is that a MTF cache will likely retain a recently looked up address translation entries fully exploiting temporal locality of communication. In one example (not shown)), the ARC 114 is located in the DYMO routing protocol 110 since the DYMO routing protocol does not have real time constraints like NAMA and the DYMO routing protocol will be usually the layer initiating the address translation using ARC 114 whenever a data (e.g., user data) needs to be routed.

The DYMO routing protocol 110 sends signals (e.g., a layer 2 query) to the NAMA scheduling protocol 118 using a connection 120a and receives signals (e.g., results of the layer 2 query) from the NAMA scheduling protocol through a connection 120b. The DYMO routing protocol 110 sends signals (e.g., a conversion request from IP address-to-node ID address conversion and visa versa) to the ARC 114 using a connection 124a and receives signals (e.g., results of the conversion request) from the ARC through a connection 124b. The DYMO routing protocol 110 sends signals (e.g., a route request, generate a new route entry) to the routing table 100 using a connection 126a and receives signals (e.g., results of the route request) from the routing table through a connection 126b. The NAMA scheduling protocol 118 send signals to the neighbor matrix table 50′ through a connection 122a and receives signals form the neighbor matrix through a connection 122b. In some examples, the connections 120a, 120b may be the same connection, the connections 122a, 122b, may be the same connection, the connections 124a, 124b may be the same connection, the connections 126a, 126b may be the same connection.

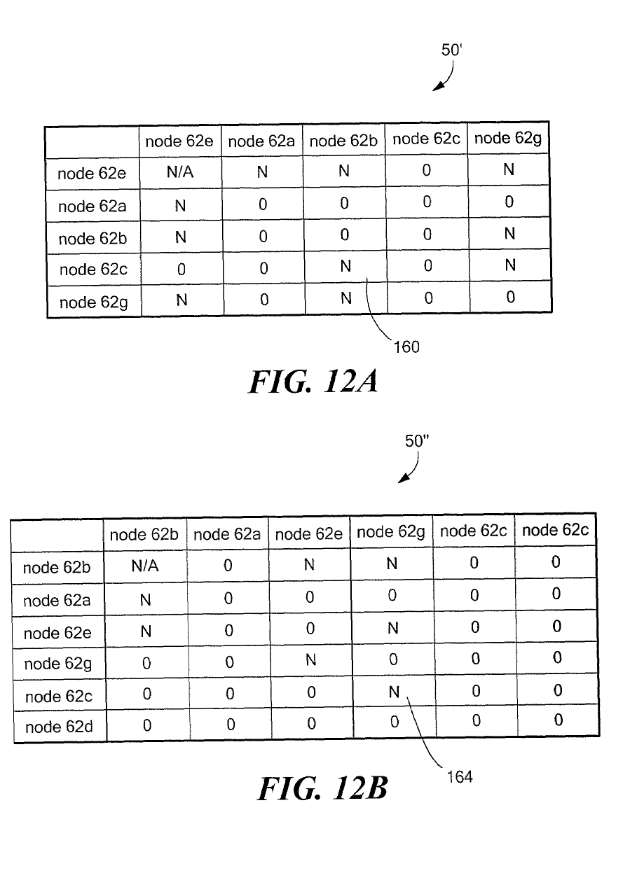

Referring to FIG. 11, cross layer communications between the network layer and the data link layer (e.g., through the connections 120a, 120b) are essential components of XRP as the communications enable efficient route discovery and maintenance by exploiting information available at each layer. In order to facilitate this communication, XRP uses packet header fields 150 that include a previous previous node (PPrev ID) field 152 to include the node ID of the node that the packet traverses through from two hops ago, that include a previous node (Prev ID) field 154 to include the node ID of the node that the packet traverses through from one hop ago, a next next ID (NNext ID) field 156 to include the node ID of the node that the packet needs to get to in two hops and a routing metric (either hop distance or link quality) field 156 as well as the Next Hop field 104, the source IP field 84 and the destination IP field 86.

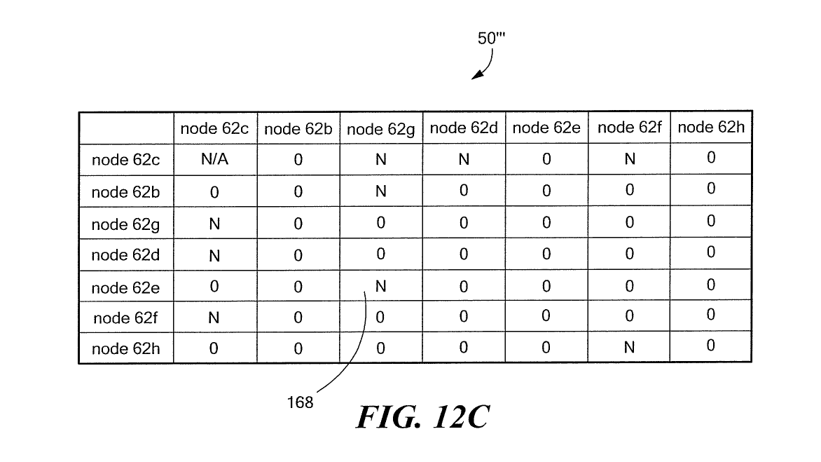

Referring to FIG. 12A, layer 2 inquiry is a process through which the DYMO routing protocol learns of the best next hop node ID of the packet destined to a particular unicast IP address. The DYMO routing protocol obtains the next hop information by inquiring using the neighbor matrix of NAMA. For example, DYMO sends a layer 2 inquiry using the connection 120a to the NAMA scheduling protocol 118. The NAMA scheduling protocol 118 sends an inquiry to its neighbor matrix 50′ using the connection 122a. The neighbor matrix 50′ returns the result using the connection 122b. NAMA checks its neighbor matrix 50′, when it is inquired for NextHop information by the DYMO routing protocol. In the example, NAMA is inquired about node 62c which is a two-hop neighbor of node 62e. Since a neighbor matrix 50′ of node 62e has node 62b as a potential relay for the node 62c (i.e., a field 160 is marked with a nonzero value), NAMA returns node 62b as a next hop of node 62c as the result the inquiry. The information returned by NAMA can then be used to update the route entry used by the DYMO routing protocol which in turn is used for formatting the header of the received packet. The packet received by the DYMO routing protocol is then formatted using the newly created route entry information based on Layer 2 Inquiry.

The formatted packet is sent to node 62b which the packet has designated as the next hop. Upon receiving the packet, node 62b forwards the header information of the packet to the DYMO routing protocol for route inquiry called “Layer 3 Inquiry” and occurs for every received packet for route maintenance and update. Through the Layer 3 Inquiry, it is possible for the DYMO routing protocol to learn any new route information or changes in the existing route due to intra-zone routing performed by NAMA.

For example, node 62b makes an inquiry to the DYMO routing protocol 118 with includes the following header information: Source/Destination IP 84, 86, PPrev ID/Prev ID 152, 154, NNext ID/Next Hop 156, 104, and Hop Count 158. The Source IP 84, PPrev ID/Prev ID 152, 154, and Hop Count 158 fields together are used for updating reverse path to the Source IP address. The reverse path information is updated in the routing table 100 only if there is no existing entry in the routing table for the source IP address or the route metric (hop count, or link quality) stored in the routing table is greater than the fields from the packet. The update can also occur if NNextID/NextHop 156, 104 fields for the existing route entry is incomplete (e.g., NextHop=0 or NNextID=0). When an existing route entry's route metric is equal to the route metric (e.g., hop count) obtained from a packet while the PPrev ID/Prev ID 152, 154 information is different, then a tie breaker is used for deciding whether to accept or reject the update. Since the node 62b does not have any route entry to the source IP address of 1.1.8.7, a new entry is created using the information obtained from the packet header.

Route discovery mechanism in XRP is very similar to route discovery mechanism used by the DYMO routing protocol. The difference of XRP's route discovery mechanism from that of the route discovery used by the DYMO route protocol is that XRP uses a Cross Layer Inquiry.

When a node receives a packet from a layer above and discovers that the packet's destination address is not in its routing table 100 used in the DYMO routing protocol, the node then initiates a Layer 2 Inquiry. If the route to the destination is found through the Layer 2 Inquiry then a new route is created based on the information obtained from Layer 2 Inquiry and the packet is subsequently transmitted using the new route entry. On the other hand, if Layer 2 Inquiry fails to find the route, then the node then initiates a route discovery mechanism similar to the one described above in reference to the DYMO routing protocol. XRP's route discovery starts when a node forms a RREQ packet which includes the target IP address of the destination, RREQ ID and a route metric (i.e. hop count) value set to an initial value. Whenever a node receives a RREQ packet and the RREQ packet is considered to be not old (e.g., fresh or has a better metric than the existing route), the RREQ packet is then processed to form a reverse path. The reverse path formation is accomplished by passing the RREQ header information to DYMO as a part of Layer 3 Inquiry process. In addition to forming a reverse path which consists of the target address and the next hop, the PPrev ID information of RREQ is also stored in the route entry as NNextHop information to indicate the two-hop distance information. RREQ is then forwarded to the network 60.

As in DYMO, the RREQ packet traverses the network to form reverse paths. Each time the RREQ packet is processed by a node and forwarded, the Prev ID/PPrev ID fields 154, 152 are updated to reflect the two-hop path the RREQ packet has taken so far. Prev ID/PPrev ID fields 154, 152 along with the source IP address are used for the creation of a new route entry. For example, when the RREQ finally gets to node 62h which is the destination of the RREQ packet (IP address 1.1.8.4), a new route entry is created in node 62h based on the information obtained from the RREQ (e.g., the source IP address 84 is 1.1.8.7, the NextHop 104 is 6, and the NNextID is 3).

Once a RREQ packet is received by the destination node, the destination node then forms a RREP packet in response. The newly constructed RREP packet includes a RREP ID matching the original RREQ message and also includes source and destination IP addresses. A RREP packet also includes PPrev ID/Prev ID fields 152, 154 like the format of the RREQ packet and a Next hop/NNext ID fields 104,156 obtained from the routing table 100 belonging to each node along the route. As a RREP path traverses along the already established reverse path, a forward path back to the destination node is established by using the header information from the RREP packet. Once bi-directional route is established, data can be routed using the route. Each data packet in XRP carries Next Hop/NNext ID fields 104, 156 and PPrev ID/Prev ID fields 152, 154 along with the route metric 158 for persistent route maintenance.

Cross Layer Inquiry is critical component that achieves proactive route maintenance in XRP. Using XRP framework, even where there is a route failure, each node can quickly discover alternate routes, if such routes exist, without generating RERR packet and RREQ/RREP packet exchange which is the main source of latency. Moreover, through the use of Layer 3 Inquiry, alternate route can quickly learn a new route without need for new route discovery phase. For example, Cross Layer Inquiry may be used in proactively maintaining routes in XRP.

One of the current interactions between NAMA and the DYMO routing protocol is periodic updates of one-hop neighbor information by NAMA for the DYMO routing protocol. In XRP, the neighbor information passed to the DYMO routing protocol by NAMA carries both one- and two-hop neighbor information (e.g., defining a zone). The two-hop neighbor information ensures that the route entry is not removed unless both nodes listed in the NextHop field 104 and the NNextID field 156 are no longer available as the node's one-hop and two-hop neighbor. If just one of the neighbors is no longer present in the node's two-hop range, the route is still maintained, and the node then uses Layer 2 Inquiry to determine an alternate route without triggering a RERR packet.

XRP neighbor processing modifies a route entry when neighbor information changes due to a link breakage. For example, the connection 64a between the nodes 62b, 62c fails. At node 62b, the original value for the NextHop field 104 and the NNextID field 156 include node ID values of “3” and “6” respectively referring to the node 62c and the node 62f respectively (see, for example, table 70). However, when the neighbor information from NAMA indicates that node 62c is no longer considered to be a one-hop neighbor but instead a two-hop neighbor, and node 62f is no longer within the two-hop neighborhood of the node 62b, the route entry is modified such that node 62c is moved into the NNextID field 156 (e.g., the NNextID field 156 now contains a “3” to indicate an node ID of 3) and the NextHop field 104 is initialized to zero which indicates that updated NextHop information needs to be obtained through Layer 2 Inquiry. A similar process occurs at node 62c where the information from the NextHop field 104 is initialized to zero since the current neighbor information indicates that the node 62b is no longer a one-hop neighbor but rather a two-hop neighbor of the node 62c. However, unlike node 62b, information from the NNextID field 156 for node 62c's route entry is unchanged since node 62e which is designated as the two-hop neighbor still remains to be node 62c's two-hop neighbor. Keeping node 62e as the two-hop neighbor prevents the route from increasing in size.

Once the routes are modified to reflect the changes in the neighbor information, the routes remain modified until the routes are actually used to route data. When a data arrives at a node (from a node's application or from other node's for routing purpose), the routing table 100 is referenced for routing information. If the route entry's information in the NextHop field 104 is found to be zero, the node then initiates Layer 2 Inquiry to obtain the optimal NextHop value.

Referring to FIGS. 12B and 12C, for example, at node 62b, the one-hop information for two-hop neighbor of node 62c is obtained by examining the rows corresponding to node 62c in a neighbor matrix of node 62b. As the row is examined, any entry containing non-zero values (e.g., expressed as letter “N”) indicates that the node corresponding to the entry's column can be potential a one-hop neighbor. The only column that corresponds to a non-zero value entry along the row occurs in a field 164 which corresponds to the node 62g (i.e., the row for node 62c only includes one N value under the column for the node 62g).

As for node 62c, node 62g is also selected as the one-hop neighbor for the route entry corresponding to 1.1.8.7 since node 62g is found to be the only relay that can reach node 62e as indicated by a field 168 in a neighbor matrix 50′″ of the node 62c (i.e., the row for node 62e only includes one N value under the column for the node 62g). In other examples, searching for an optimal NextHop value in a neighbor matrix that includes multiple non-zero entries, other factors such as link quality or node weight, for example, are evaluated in deciding the optimal NextHop.

Once the NextHop information is obtained for a data packet and the route entry is updated accordingly, the packet can be routed using the newly updated routing information. However, after the initial route update through Layer 2 Inquiry, it is possible that the route between the source and the destination is either incomplete or sub-optimal. The initial route's incomplete or sub-optimal condition is caused by letting each node performs its own route selection without any coordination or consultation with other nodes. The condition is resolved in XRP by exploiting the header information in the data packet. XRP allows each node to glean information from the data packet to readjust the route through the use of Cross Layer Inquiry such that the route from the source and destination converges to a fully bi-directional and optimal route. This process of route optimization in XRP is called “route annealing” similar to annealing process in metallurgy.

XRP also performs route maintenance. In one example route is updated after the Layer 2 Inquiry by the node 62b and the node 62c. Even though an optimal route exists between node 62e and the node 62h (e.g., node 62e→node 62g→node 62c→node 62f→node 62h), the initial route formed through NAMA Inquiries consist of nodes 62e, 62b, 62g, 62c, 62f, 62h. Moreover, the newly formed route is incomplete since node 62g does not yet know that it's a part of the newly formed route. The route annealing process starts as data flows using the new route. As the data packet traverses the route, the route information at the intermediate nodes along the route is updated and when the data arrives at the destination route annealing process is finished.

When a node, upon receiving a data packet from the network, discovers that there is no existing route to the destination and an alternate route cannot be discovered using Layer 2 Inquiry, the node must generate RERR such that the source of the data packet can reinitiate a route discovery phase. For example, a breakage in the link 64d between the node 62c and 62f cannot be mended using Layer 2 Inquiry. Each data packet received by node 62c and node 62f destined for IP addresses 1.1.8.4 and 1.1.8.7 respectively will trigger RERR transmission. Each RERR transmission is broadcasted, and carries a Prev ID field 154 and a PPrev ID field 152.

When a node receives the RERR packet, it processes the RERR packet and forwards the RERR packet back out to the network 60 if (1) a node has a route entry's destination IP matching an Unreachable field of RERR packet, (2) a Route entry's NextHop information is zero or it matches Prev ID field 154 of the RERR packet; and (3) a Route entry's NNextHop information is zero or PPrev ID field 152 of the RERR packet is zero or the Route entry's NNextID 156 matches the PPrev ID field 152 of the RERR packet.

If any of the previous conditions are not met, the RERR packet is simply dropped by the node without further processing.

XRP's unique features allow nodes in the network to proactively react to changes in the network topology using NAMA's neighbor information while minimizing routing overhead by utilizing on-demand protocols outside the zone. NAMA Relay's use of data link layer in performing intra-zone routing provides several advantages over the original ZRP approach.

For example, in XRP, there is no extra routing overhead generated by proactive intra-zone routing. Since XRP exploits the information that is already embedded in the data link layer, there is no extra penalty of running the proactive intra-zone routing protocol.

Since the DYMO routing protocol enables each node to store the route information that each node is part of, any route maintenance performed by NAMA is then readily communicated to the DYMO routing protocol all within same node without needing to send the update back to the source.

The DYMO routing protocol is a distance vector routing algorithm that does not require each packet to carry the complete route information. Since the route information is stored at each node along the route, packet header size is reduced since each data does not need to carry the routing information. This header size reduction using the DYMO routing protocol saves valuable bandwidth by minimizing overhead created from packet headers.

NAMA's neighbor information has the complete topology of each node's one- and two-hop neighborhoods. The neighbor information contains not only whether particular neighbor is either one or two hop, but it also contains how these neighbors are connected to each other. By constantly exchanging information about the neighborhood with each other, as a part of NAMA scheduling algorithm, each node possesses the complete topological knowledge of its one- and two-hop neighbors or its zone. Unlike a destination sequenced-distance vector (DSDV) protocol used in ZRP, XRP can use the topological knowledge from neighbor information in allowing each node to quickly reroute packets once it discovers route failures. XPR's active route maintenance using the data link layer detects a node's failure and the packets are rerouted using NAMA neighbor information.

One of the differences between XPR and ZRP comes from XRP's layered approach of providing two different routing paradigms. The approach has practical significance since having each layer to focus on its own routing paradigm makes the code implementation and packet format design much simpler. XPR takes full advantages of modular architecture using layered approach while exploiting information across the layer boundary to achieve routing efficiency.

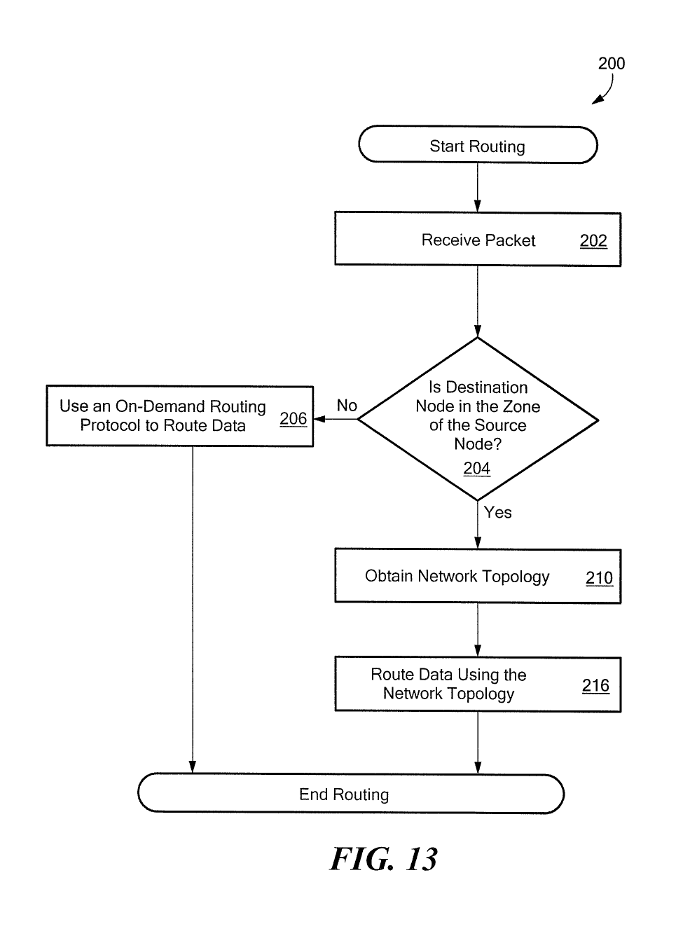

Referring to FIG. 13, one process used by nodes 62a-62h in the network 60 to process a packet is a process 200. After a packet is received (202), it is determined whether the destination node is the zone (e.g., a two-hop neighborhood) (204). If the destination is outside the zone, an on-demand routing protocol (e.g., DYMO) is used to route the packet (206). If the destination node is within the zone, the network topology is obtained (e.g., by using a neighborhood matrix 50 used in NAMA) (210) and the packet is routed using the network topology (216).

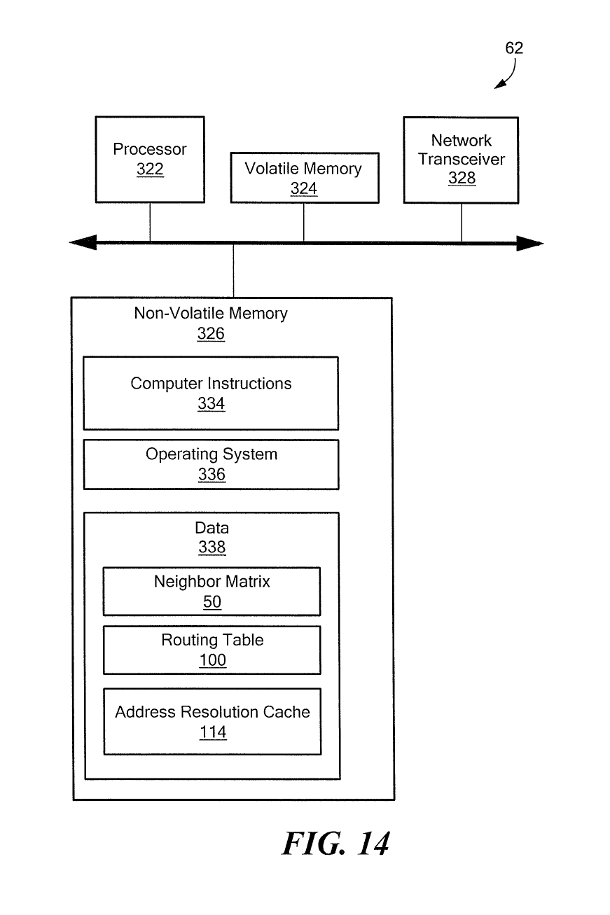

Referring to FIG. 14, nodes 62a-62h may be represented by a node 62. The node 62 includes a processor 322, a volatile memory 324, a non-volatile memory 326 (e.g., a hard disk) and a network transceiver 328. The non-volatile memory 326 stores computer instructions 334, an operating system 336 and node data 338 such as the neighbor matrix 50. The data 338 includes the neighbor matrix 50, the routing table 100 and the address resolution cache 114. The transceiver 328 is used to communicate with the other network nodes. In one example, the computer instructions 334 are executed by the processor 322 out of volatile memory 324 to perform at least some or part of process 200.

The processes described herein (e.g., the process 200) are not limited to use with the hardware and software of FIG. 14; it may find applicability in any computing or processing environment and with any type of machine or set of machines that is capable of running a computer program. The processes may be implemented in hardware, software, or a combination of the two. The processes may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform the processes and to generate output information.

The system may be implemented, at least in part, via a computer program product, (e.g., in a machine-readable storage device), for execution by, or to control the operation of, data processing apparatus (e.g., a programmable processor, a computer, or multiple computers)). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer to perform process 80. Process 200 may also be implemented as a machine-readable storage medium, configured with a computer program, where upon execution, instructions in the computer program cause the computer to operate in accordance with the processes (e.g., the process 200).

The processes described herein are not limited to the specific embodiments described herein. For example, the process 200 is not limited to the specific processing order of FIG. 13. Rather, any of the processing blocks of FIG. 13 may be re-ordered, combined or removed, performed in parallel or in serial, as necessary, to achieve the results set forth above.

The processing blocks in FIG. 13 associated with implementing the system may be performed by one or more programmable processors executing one or more computer programs to perform the functions of the system. All or part of the system may be implemented as, special purpose logic circuitry (e.g., an FPGA (field programmable gate array) and/or an ASIC (application-specific integrated circuit)).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer include a processor for executing instructions and one or more memory devices for storing instructions and data.

Elements of different embodiments described herein may be combined to form other embodiments not specifically set forth above. Other embodiments not specifically described herein are also within the scope of the following claims.

What is claimed is:

1. A method comprising:
receiving a packet at a first node, the first node comprising a processor;
determining, at the first node, whether a destination node of the packet is within a zone of the first node;
using, at the first node, an on-demand routing protocol to route data from the first node to the destination node if the destination node is outside the zone of the first node; and
using a network topology, stored at the first node, to route the packet from the first node to the destination node if the destination node is within the zone of the first node.

2. The method of claim 1 wherein using a routing protocol to route data from the first node to the destination node if the destination node is outside the zone of the source node comprises using a Dynamic Mobile Ad hoc Network (MANET) On-demand (DYMO) routing protocol.

3. The method of claim 1 wherein using a network topology, stored at the first node, if the destination node is within the zone of the first node comprises using a network topology stored at a data link layer.

4. The method of claim 3 wherein using a network topology stored at the data link layer comprises information on a one-hop neighbor of the first node and information on a two-hop neighbor of the first node.

5. The method of claim 3, further comprising using an address resolution cache (ARC) to translate data link layer addresses to network layer addresses.

6. The method of claim 1 wherein using a network topology, stored at the first node, to route the packet from the first node to the destination node if the destination node is within the zone of the first node comprises using a network topology from Node Activation Multiple Access (NAMA).

7. The method of claim 6 wherein using a network topology, stored at the first node, to route the packet from the first node to the destination node if the destination node is within the zone of the first node comprises using a neighbor matrix of the first node covering a two-hop neighborhood.

8. The method of claim 1 wherein determining whether a destination node is within a zone of a first node comprises determining whether a destination node is within a neighborhood of the first node.

9. The method of claim 1 wherein determining whether a destination node is within a zone of a first node comprises determining whether a destination node is within a two-hop neighborhood of the first node.

10. An apparatus to route data, comprising:
circuitry to:
receive a packet at a first node, the first node comprising a processor;
determine, at the first node, whether a destination node of the packet is within a zone of the first node;
use, at the first node, an on-demand routing protocol to route data from the first node to the destination node if the destination node is outside the zone of the first node; and
use a network topology, stored at the first node, to route the packet from the first node to the destination node if the destination node is within the zone of the first node.

11. The apparatus of claim 10 wherein the circuitry comprises at least one of a processor, a memory, programmable logic and logic gates.

12. The apparatus of claim 10 wherein the circuitry to use a routing protocol to route data from the first node to the destination node if the destination node is outside the zone of the source node comprises circuitry to use a Dynamic Mobile Ad hoc Network (MANET) On-demand (DYMO) routing protocol.

13. The apparatus of claim 10 wherein the circuitry to use a network topology, stored at the first node, if the destination node is within the zone of the first node comprises circuitry to use a network topology stored at a data link layer.

14. The apparatus of claim 13 wherein the circuitry to use a network topology stored at the data link layer comprises circuitry to use information on a one-hop neighbor of the first node and information on a two-hop neighbor of the first node.

15. The apparatus of claim 13, further comprising circuitry to use an address resolution cache (ARC) to translate data link layer addresses to network layer addresses.

16. The apparatus of claim 10 wherein the circuitry to use a network topology, stored at the first node, to route the packet from the first node to the destination node if the destination node is within the zone of the first node comprises circuitry to use a network topology from Node Activation Multiple Access (NAMA).

17. The apparatus of claim 16 wherein the circuitry to use a network topology, stored at the first node, to route the packet from the first node to the destination node if the destination node is within the zone of the first node comprises circuitry to use a neighbor matrix of the first node covering a two-hop neighborhood.

18. The apparatus of claim 10 wherein circuitry to determine, at the first node, whether a destination node of the packet is within a zone of the first node comprises circuitry to determine whether a destination node is within a neighborhood of the first node.

19. The apparatus of claim 10 wherein the circuitry to determine, at the first node, whether a destination node of the packet is within a zone of the first node comprises circuitry to determine whether a destination node is within a two-hop neighborhood of the first node.

20. An article comprising a machine-readable storage medium that stores executable instructions to route data, the executable instructions causing a machine to:
receive a packet at a first node, the first node comprising a processor;
determine, at the first node, whether a destination node of the packet is within a zone of the first node;
use, at the first node, a Dynamic Mobile Ad hoc Network (MANET) On-demand (DYMO) routing protocol to route data from the first node to the destination node if the destination node is outside the zone of the first node; and
use a network topology, stored at a data link layer of the first node, to route the packet from the first node to the destination node if the destination node is within the zone of the first node.

21. The article of claim 20 wherein the instructions causing a machine to use a network topology stored at the data link layer comprises instructions causing a machine to use information on a one-hop neighbor of the first node and information on a two-hop neighbor of the first node.

22. The article of claim 21, further comprising instructions causing a machine to use an address resolution cache (ARC) to translate data link layer addresses to network layer addresses.

23. The article of claim 20 wherein the instructions causing a machine to use a network topology, stored at the first node, to route the packet from the first node to the destination node if the destination node is within the zone of the first node comprises instructions causing a machine to use a network topology from Node Activation Multiple Access (NAMA).

24. The article of claim 23 wherein the instructions causing a machine to use a network topology, stored at the first node, to route the packet from the first node to the destination node if the destination node is within the zone of the first node comprises instructions causing a machine to use a neighbor matrix of the first node covering a two-hop neighborhood.

25. The article of claim 20 wherein the instructions causing a machine to determine, at the first node, whether a destination node of the packet is within a zone of the first node comprises instructions causing a machine to determine whether a destination node is within a two-hop neighborhood of the first node.
